(19) United States
(12) Patent Application Publication
(10) Pub. No.: US 2004/0224058 A1
(43) Pub. Date: Nov. 11, 2004

(54) Maltitol solutions with high maltitol content and methods of making same

(75) Inventors: Mary L. Cunningham, Wilmington, DE (US); Charles B. Walker, Elkton, MD (US)

Correspondence Address: CONNOLLY BOVE LODGE & HUTZ, LLP, P O BOX 2207, WILMINGTON, DE, 19899, US

(73) Assignee: SPI Polyols, Inc., New Castle, DE

(21) Appl. No.: 10/804,502

(22) Filed: Mar. 19, 2004

Related U.S. Application Data
(60) Provisional application No. 60/456,163, filed on Mar. 20, 2003.

(51) Int. Cl. A23G 3/30; B65B 55/00

(52) U.S. Cl. 426/234

(57) ABSTRACT

The present invention relates to maltitol solutions having a high maltitol content and methods of making the maltitol solutions. The maltitol solutions have a variety of uses including, but not limited to, use as a sweetener, plasticizer or viscosity modifier, humectant, coating material or coating ingredient.

### BACKGROUND OF THE INVENTION

1. Field of the Invention

The present invention relates to maltitol solutions having a high maltitol content and methods of making the maltitol solutions. The maltitol solutions have a variety of uses including, but not limited to, use as a sweetener, plasticizer or viscosity modifier, humectant, coating material or coating ingredient.

2. Description of the Related Art

Maltitol is a polyol that is produced from the catalytic hydrogenation of high maltose corn syrup. Maltitol has approximately 90 percent of the sweetness of sugar (i.e., sucrose) and is generally recognized to have a caloric value of about 2.1 kcal/g. Products sweetened with maltitol meet the FDA's definition of “no sugar added” or “sugarless.” These properties allow maltitol to be used as a reduced-calorie sweetener in the United States. Maltitol is relatively slowly absorbed by the human digestive system, yet has a laxation threshold that is about two times that of sorbitol. Crystalline maltitol also has a heat of solution comparable to sucrose, making it a popular sugar-free substitute sweetener. Maltitol is commonly used in candies, chewing gum, chocolates, jams and jellies, and frozen desserts.

Maltitol has a pleasant sweet taste and because maltitol has a relative sweetness value of 90 (sucrose=100), for most applications there is no need to adjust the sweetness when replacing sucrose with an equivalent amount of maltitol. Unlike sorbitol, maltitol does not exhibit a strong cooling effect. Maltitol also has very good heat stability, which means that it can be handled at high temperature without decomposition or color formation. Due to the nature of maltitol and the virtual absence of reducing sugars, maltitol can be concentrated to very high dry substance levels without unwanted discoloration or browning reactions. Maltitol also has excellent humectancy capacity due to its hygroscopic character.

Hydrogenated starch hydrolysate (“HSH”) is a class of polysaccharides that includes hydrogenated glucose syrups, maltitol syrups, and sorbitol syrups, and is found in a wide variety of foods. Hydrogenated maltodextrins are also within the class of HSH polysaccharides. HSH serves a number of functional roles, including use as bulk sweeteners, viscosity or bodying agents, humectants, crystallization modifiers, cryoprotectants and rehydration aids. They also can serve as sugar-free carriers for flavors, colors and enzymes.

Hydrogenated starch hydrolysates are produced by the partial hydrolysis of corn, wheat, tapioca, rice, or potato starch with the subsequent hydrogenation of the hydrolysate at high temperature under pressure. The end product is an ingredient composed of sorbitol, maltitol, and higher hydrogenated saccharides. By varying the conditions and extent of the hydrolysis, the relative occurrence of various mono-, di-, oligo- and polymeric hydrogenated saccharides in the resulting product can be obtained. Therefore, a wide range of polyols that can satisfy varied requirements with respect to different levels of sweetness, viscosity and humectancy can be produced.

Hydrogenated mono-, di-, oligo- and poly-saccharides are characterized by the degree of polymerization (DP or HP) after hydrogenation. Hydrogenated monosaccharides have a HP=1. Hydrogenated disaccharides have a HP=2. Hydrogenated tri-, quat-, penta-, hexa-, hepta-, octa-, nona-, and deca-saccharides have HPs of 3, 4, 5, 6, 7, 8, 9, and 10, respectively. Hydrogenated undeca- and greater saccharides have HPs of 11 or greater. The HP may be determined by routine HPLC analysis.

Generally, the term hydrogenated starch hydrolysate can correctly be applied to any polyol produced by the hydrogenation of the saccharide products of starch hydrolysis. In practice, however, certain polyols such as sorbitol, mannitol, and maltitol are referred to by their common chemical names. “Hydrogenated starch hydrolysate” is more commonly used to describe the broad group of polyols that contain substantial quantities of hydrogenated oligo- and polysaccharides in addition to any monomeric or dimeric polyols (sorbitol/mannitol or maltitol, respectively).

The hydrogenation of maltodextrin is disclosed in Barressi, et al. WO 99/36442, which is herein incorporated by reference. For example, 10 DE maltodextrin (MALTRIN M1 00, Grain Processing Corporation, Muscatine, Iowa) is hydrogenated by dissolving the maltodextrin powder in water to form a 55 weight percent solids solution. The solution is charged to a reactor with 5 percent Raney nickel (solids basis) as the hydrogenation catalyst. The reactor is then pressurized with hydrogen to 500 psi, heated to 130° C., and stirred. The reactor is maintained at this temperature and pressure until sampling shows that the reducible sugar has been converted to polyol. The reaction time is typically between 4 to 12 hours, depending on the size and configuration of the reactor used. When the reaction is completed, the stirring is stopped and the catalyst is allowed to settle. The hydrogenated maltodextrin reaction product is then decanted and filtered to remove fines. The filtered reaction product is next ion-exchanged through a strong cation and strong base anion using methods well known in the art. Finally, the reaction product is evaporated to about 60 to 70 weight percent solids for storage.

U.S. Pat. No. 5,571,547 to Serpelloni et al., which is hereby incorporated by reference, discloses a two-step process of producing a hard coating on the surface of a product. The first step includes the application of a syrup containing at least 90% of a polyol chosen from sorbitol, maltitol, mannitol, xylitol, erythritol, lactitol and isomalt to the surface to be coated. The second step includes the application, in powder form, to the surface that has been coated with the syrup, of a quantity of powder which has a purity higher than 95% with respect to the same polyol contained in the syrup.

U.S. Pat. No. 5,470,591 to Ribadeau-Dumas et al., which is hereby incorporated by reference, discloses an agent for controlling the propagation of crystallization of maltitol present in confectionary and the use in confectionary of a sweetening syrup that is crystallizable to maltitol and which contains the agent for controlling crystallization. As described in this patent, sweetening syrups that contain high maltitol contents (greater than about 80% by weight maltitol based on the dry matter content of the syrup) are always crystallizable and are not stable over time. To solve this problem, the patentees used an agent for controlling the propagation of crystallization wherein the agent was molecules having a molecular weight greater than 1,300 and the agent was present in the maltitol syrup in an amount of more than 3% by weight of the dry matter present in the syrup.

U.S. Pat. No. 5,629,042 to Serpelloni et al., which is hereby incorporated by reference, discloses a sugarless boiled sweet containing a water crystallizable polyol and carbohydrates, e.g., saccharides. The boiled sweet has a water content greater than three percent and a glass transition temperature greater than or equal to 38° C., the glass transition temperature (T_{g}) being measured at a water content of about 3.2 percent.

U.S. Pat. No. 4,248,945 to Stroz et al., which is hereby incorporated by reference, shows hydrogenated starch hydrolysates having total solids contents of about 72 to 80 weight percent. Based on the dry hydrogenated starch hydrolysates, the total solids contents consist of about 4 to 20 weight percent sorbitol (hydrogenated monosaccharide), 20 to 65 weight percent hydrogenated disaccharides (e.g., maltitol), 15 to 45 weight percent tri- to hepta-hydrogenated oligosaccharides, and 1.0 to 35 weight percent hydrogenated polysaccharides higher than hepta.

U.S. Pat. No. 4,445,938 to Verwaerde et al. which is hereby incorporated by reference, discloses dry hydrogenated starch hydrolysates consisting of, based on total solids content, less than 14 weight percent of hydrogenated monosaccharides, e.g., sorbitol, less than 35 weight percent of hydrogenated disaccharides, e.g., maltitol, 12 to 18 weight percent of hydrogenated trisaccharides, between 42 and 70 weight percent of hydrogenated quat- to deca-oligosaccharides, and less than 32 weight percent of hydrogenated polysaccharides greater than deca. The Verwaerde composition provides a more stable hydrogenated starch hydrolysate than one which has 15.5 or 30.0 weight percent of hydrogenated quat- to deca-oligosaccharides.

### SUMMARY OF THE INVENTION

The object of the present invention is to provide a maltitol solution having a high maltitol content. The solvent for the maltitol solution is water. The maltitol solution has the following composition:

| | |
|---|---|
| Maltitol | 85 to 99% by weight of solids |
| Sorbitol | 0.1 to 7% by weight of solids |
| HP 3 | 0.1 to 6% by weight of solids |
| HP 4+ | 0.1 to 3% by weight of solids |

The total solids in the maltitol solutions of the present invention are from 55 to 70% by weight. Certain maltitol solutions of the present invention have total solids contents of from 58 to 68% or from 62 to 66% by weight. A preferred maltitol solution of the present invention has a total solids content of about 64 to 66% by weight.

The maltitol solution of the present invention is further characterized by its stability (e.g., its low rate of crystallization), humectancy, water activity, sweetness, adhesion, water absorption, and flavor properties. These and other objects and advantages of the present invention can be appreciated by referring to the following description and claims or may be learned by the practice of this invention.

### BRIEF DESCRIPTION OF THE DRAWING

FIG. 1 shows the preferred process of the present invention in flow-chart form.

### DETAILED DESCRIPTION OF THE INVENTION

The object of the present invention is to provide a maltitol solution having a high maltitol content. The solvent for the maltitol solution is water. The maltitol solution has the following composition:

| | |
|---|---|
| Maltitol | 85 to 99% by weight of solids |
| Sorbitol | 0.1 to 7% by weight of solids |
| HP 3 | 0.1 to 6% by weight of solids |
| HP 4+ | 0.1 to 3% by weight of solids |

In a preferred embodiment of the invention, the maltitol solution has the following composition:

| | |
|---|---|
| Maltitol | 88 to 97% by weight of solids |
| Sorbitol | 0.5 to 5% by weight of solids |
| HP 3 | 0.5 to 4% by weight of solids |
| HP 4+ | 0.1 to 3% by weight of solids |

In another preferred embodiment of the present invention, the maltitol solution has the following composition:

| | |
|---|---|
| Maltitol | 90 to 96% by weight of solids |
| Sorbitol | 1.0 to 3% by weight of solids |
| HP 3 | 1.0 to 3% by weight of solids |
| HP 4+ | 0.1 to 3% by weight of solids |

The total solids in the maltitol solutions of the present invention are from 55 to 70% by weight. Certain maltitol solutions of the present invention have total solids contents of from 58 to 68% or from 62 to 66% by weight. A preferred maltitol solution of the present invention has a total solids content of from about 64 to 66% by weight.

The glass transition temperature (T_{g}) of the maltitol solutions, determined by differential scanning calorimetry (TA instruments, model #2010, including refrigerated cooling system by TA Instruments) on a hard boiled candy formed from the maltitol solutions with a water content of 0.3 to 1.5% by weight, is preferably within the range of 15 to 30. C. However, certain maltitol solutions of the invention can have glass transition temperatures of 17 to 27° C., 20 to 26° C., or even 21 to 25° C.

The water activity (a_{w}) of the maltitol solutions of the present invention, determined by a water activity meter (Rotronic, model #'s Hygropalm (handheld) and AW-DIO (benchtop)) using a 65% by weight solids solution at 23° C., is preferably in the range of 0.78 to 0.90. However, certain maltitol solutions of the invention can have water activities of from 0.80 to 0.88, 0.82 to 0.87, or even 0.84 to 0.85.

The inventors have unexpectedly found that the maltitol solution of the present invention is stable (i.e., has a low rate of maltitol crystallization from the solution) even though the maltitol solution has a high maltitol content of from 85% to 99% by weight of the solids and a high solids content of from 55 to 70% by weight. What is even more surprising is that the maltitol solutions of the present invention are stable at normal ambient temperatures of from 20° C. to 35° C. and even at elevated temperatures of from 38 to 42° C. Until the maltitol solution of the present invention was developed, it was generally believed that maltitol solutions having a high solids content and a high maltitol content were unstable (i.e., maltitol would crystallize from solution over time) and would not have a sufficient shelf life. It was believed that to achieve stability against the crystallization of maltitol from the solution, it was necessary to decrease the solids content and thereby increase the water content. However, this led to other stability problems, namely the growth of microorganisms in the solutions. Applicants believe that they are the first to achieve a maltitol solution having both a high solids content and a high maltitol content that is stable (both from a microbial standpoint and a crystallization over time standpoint) at normal ambient temperatures and elevated temperatures (e.g., from 38 to 42° C.) and does not require the presence of additional stabilization ingredients (such as the molecules with a molecular weight of greater than 1,300 that were used in U.S. Pat. No. 5,470,591).

The maltitol solutions of the present invention can be produced by the method described below. While the method described below is the preferred method of producing the maltitol solutions of the present invention, it may not be the only method. Accordingly, the method should be viewed as being illustrative and not necessarily limiting.

The feedstock for the method is maltose (HP 2), glucose (HP 1) and a minor amount of HP 3+ compounds. The preferred composition of the feedstock is: maltose—95% by weight minimum; glucose—2% by weight maximum; and HP 3+ compounds—5% by weight maximum. The components of the feedstock can be in liquid or solid form initially. If a component is in solid form initially, it is dissolved in deionized water before use.

As a first step of the method, the components of the feedstock are collected in a container (hereafter referred to as the raw material feed tank) and held at a temperature of from about 25° C. to 40° C., preferably 30° C. to 35° C. The feedstock in the raw material feed tank is sampled and analyzed for water content so that final adjustments to the solids content can be made in the raw material feed tank before the feedstock is sent to the reactor(s). The desired water content of the feedstock is from 55 to 65% by weight. The raw material feed tank can have one or more stirring or agitation means which can be used to keep the feedstock in a homogeneous state.

In the second step of the process, the feedstock is sent from the raw material feed tank to one or more reactors. The reactors are designed to operate elevated temperatures of from 100 to 190° C., preferably from 100 to 180° C., most preferably from 110 to 170° C., and at elevated pressures of greater than 200 psig, preferably from 200 to 2,500 psig, more preferably from 400 to 1,000 psig. The reactors should contain mixing elements so that the material in each reactor can be thoroughly and continuously mixed during the reaction stage. For example, the reactors can be jacketed, stainless steel, vertical stirred reactors. One or more catalysts are used in the reactors during the reaction stage of the process. Suitable catalysts are raney nickel catalysts and other catalysts that are known in the art to promote hydrogenation of sugars to polyols, such as maltitol. A preferred catalyst is a molybdenum promoted raney nickel catalyst. The amount of catalyst used should be about 5% by weight of the total amount of sugars present in the reactor (on a dry weight basis). Applicants have also found that it is desirable to use magnesium powder as a reaction promoter during the reaction stage of the process. The amount of magnesium powder used should be about 0.05% by weight of the total amount of sugars present in the reactor (on a dry weight basis). While applicants do not wish to be bound by any theory, it is believed that the use of the reaction promoter causes a higher conversion of the feedstock to maltitol and reduces the amount of sorbitol in the final maltitol solution (e.g., usually to less than 2.5% by weight sorbitol).

In one embodiment of the present invention, the catalyst and reaction promoter are added to the reactor(s) before the addition of the feedstock. The catalyst and reaction promoter can be added simultaneously or separately to the reactor(s). One method of adding the catalyst and reaction promoter to the reactor(s) is to slurry these substances with water and then add the slurry to the reactor(s).

The feedstock and catalyst, optionally with the reaction promoter, are held within the reactor(s) while deionized water is added to the reactor(s) (if necessary) to bring the solids content to about 50% by weight. When the solids content of the material in the reactor(s) is about 50% by weight, the reactor(s) are pressurized, subsurface, with hydrogen to about 750 psig and simultaneously heated to about 110° C., while the material in the reactor is agitated. The material in the reactor(s) is maintained at the desired temperature and pressure and agitated until the amount of reducible sugars in the material is less than 0.10% by weight (based on a 50% by weight total solids solution). The amount of reducible sugar in each reactor is measured by sampling the material in the reactor during the reaction stage and subjecting the samples to the National Formulary Reducing Sugar Test. When the reducible sugar level falls below 0.10%, the reactor heating and agitation means are turned off and the material is held in the reactor for a period of time (usually about 35 to 45 minutes) to allow the catalyst to settle out. The material in the reactor is then removed from the reactor (e.g., by pumping or decanting) in a manner that will not disturb the settled catalyst and delivered to a container (hereafter referred to as the settling tank) to allow further settling of the catalyst. The material is held in the settling tank for about 2 hours.

After the settling step, the material is removed from the settling tank and run through a filter to remove any fine catalyst particles that may remain in the material. An example of a suitable filter for this step is a plate and frame filter press.

After the filtering step, the material is transferred to a heat exchanger to reduce the temperature of the material to less than 120° F.

After the heat exchange step, the material is subjected to an ion exchange step. In a preferred embodiment of the present invention, the ion exchange step uses three ion exchange beds, in series, with the first bed being a cation bed, the second bed being an anion bed and the third bed being a mixed (cation and anion) bed. The material may be held in a holding tank as it waits to pass through the ion exchange beds.

The cation exchange bed, which is normally the first bed that the material passes through, is preferably a strongly acidic bed composed of, for example, porous styrene DVB polymer matrix resin. The anion exchange bed, which is normally the second bed that the material passes through, is preferably a strongly basic bed composed of, for example, porous type II styrene DVB polymer matrix resin. The mixed bed is a mix of strongly acidic and strongly basic resins and can be composed of, for example, the two previously stated resins at a 50/50 weight ratio.

After the ion exchange step, the material is transferred to an evaporator to remove water and obtain a product that has a final solids content of 62 to 68%, preferably 64 to 66%, by weight solids. If desirable, the material from the ion exchange step can be held in a holding tank before it is transferred to the evaporator.

The evaporator can be any evaporator that is capable of removing water from the material. The applicants have found it useful to use either a triple effect falling film evaporator or a double effect rising-falling film evaporator. The material circulates or is held within the evaporator until a certain specific gravity is obtained. The specific gravity is determined by in-line measurement on the material in a recycle line that is part of the evaporator system. (e.g., using a mass flow meter measuring temperature, vacuum, flow rate and density) and also by testing the material with a handheld hydrometer and Karl Fischer water analysis. Once the material in the evaporator has reached a specific gravity which indicates that the material has the desired solids content level (e.g., 62 to 68% by weight), the material is removed from the evaporator and transferred to a holding tank.

The material in the holding tank is the maltitol solution of the present invention. If necessary or desirable, the material in the holding tank may be subjected to finishing operations (such as further filtering) before it is shipped to market.

The following examples are provided to better understand the invention but not to limit the scope of the invention.

### EXAMPLE 1

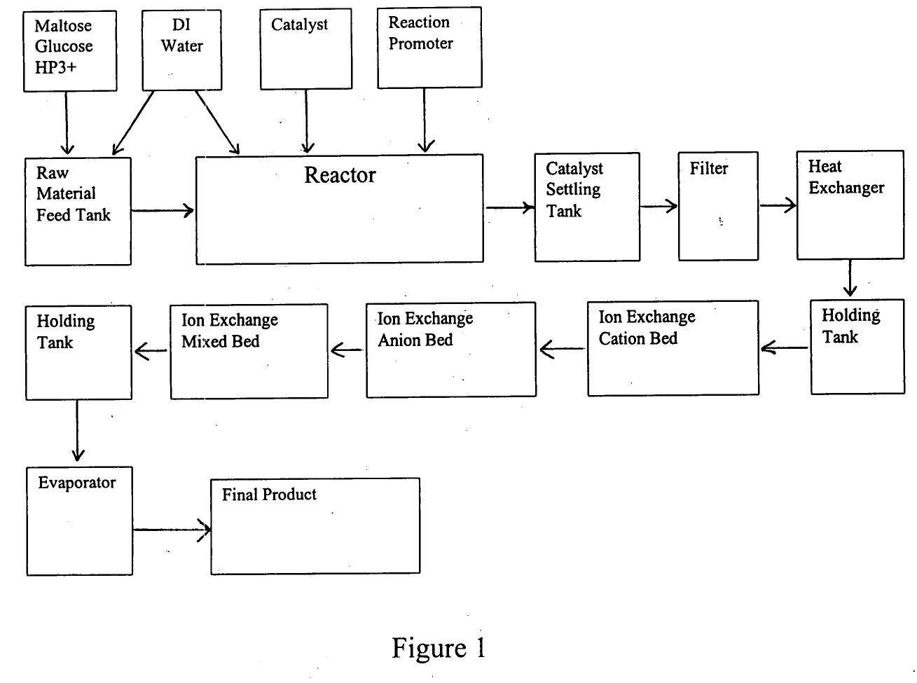

The solutions described below in Table 1 were prepared by the method described below and illustrated in FIG. 1. The HP distributions of each of the solutions, as shown in Table 1, were measured by HPLC analysis.

Method Description

The specification for the feedstock for the method was: maltose (HP 2)—95% by weight minimum; glucose (HP 1)—2% by weight maximum; and HP 3+ compounds—5% by weight maximum.

As a first step of the method, the components of the feedstock were collected in a container (hereafter referred to as the raw material feed tank) and held at a temperature of about 30° C. The feedstock in the raw material feed tank was sampled and analyzed for water content so that final adjustments to the, solids content could be made in the raw material feed tank before the feedstock was sent to the reactor(s). The desired water content of the feedstock is from 55 to 65% by weight. The raw material feed tank had stirring or agitation means which were used to keep the feedstock in a homogeneous state.

In the second step of the process, the feedstock was sent from the raw material feed tank to two stainless steel, vertical stirred, batch reactors (5000 gallon capacity each). The catalyst (either Grace Davidson, W.R. Grace Co., Raney Nickel, type 3110, molybdenum promoted or Activated Metals and Chemicals, Inc., Raney Nickel, type A-7000 series, molybdenum promoted) was added to the reactors before the feedstock was added to the reactors. This was accomplished by slurring the catalyst in water and pumping it into the reactors. A reaction promoter (magnesium powder, type TA165MP, from E.S.M. Inc.) was also added to the reactors before the addition of the feedstock following the same method that was used for the catalyst addition. The amount of catalyst added to the reactors was about 5% by weight of the total amount of sugars that were to be added to the reactor (on a dry weight basis). The amount of reaction promoter added to the reactors was about 0.05% by weight of the total amount of sugars that were to be added to the reactor (on a dry weight basis).

After the addition of the catalyst and reaction promoter to the reactors, the feedstock was pumped into the reactors along with deionized water and the amount of water added was sufficient to adjust the solids level in the reactors to about 50% by weight solids. The reactors were then pressurized (subsurface) with hydrogen to about 750 psig while being simultaneously heated so that the contents of the reactors were at a temperature of about 110° C. The feedstock in the reactors was maintained at these conditions while undergoing thorough and continuous mixing. At periodic intervals, samples of the material in the reactor were removed and analyzed (National Formulary Reducing Sugar Test) to determine the amount of reducing (or reducible) sugars present. When the reducible sugar level fell below 0.10% by weight (based on a 50% by weight total solids solution), the reactor heating and agitation means were turned off and the material was held in the reactor for a period of time (about 40 minutes) to allow the catalyst to settle out.

The material in the reactor was then removed from the reactor by decanting off (pressurized decanting) the liquid in the reactor so as not to disturb the settled catalyst. The liquid removed from the reactor was delivered to a container (hereafter referred to as the settling tank) to allow further settling of the catalyst. The material was held in the settling tank for about 2 hours.

After the settling step, the material was removed from the settling tank and run through a plate and frame filter press (Shriver; press dressed with filter cloth and paper; paper precoated with diatomaceous earth, Celite 545) to remove any fine catalyst particles that remained in the material.

After the filtering step, the material was transferred to a heat exchanger to reduce the temperature of the material to less than 120° F.

After the heat exchange step, the material was subjected to an ion exchange step. The ion exchange step used three ion exchange beds, in series, with the first bed being a cation bed, the second bed being an anion bed and the third bed being a mixed (cation and anion) bed. The material was held in a holding tank as it waited to pass through the ion exchange beds.

The cation exchange bed was a strongly acidic bed composed of porous styrene DVB polymer matrix resin (either Mitsubishi Chemical, Strong Acid type, PK220L or Rohm & Haas, Strong Acid type, CNA-200).

The anion exchange bed, was a strongly basic bed composed of porous type II styrene DVB polymer matrix resin (Mitsubishi Chemical, Strong Base, Type II, type PA418 or Dow Chemical Co., Dowex Ion Exchange Resins, Strong Base, Type II, type Dowex 22).

The mixed bed was a mix of the above strongly acidic and strongly basic resins at a 50/50 weight ratio.

After the ion exchange step, the material was transferred to and held in a holding tank before it was sent to an evaporator to remove water and obtain a product that had a final solids content of 64 to 66% by weight solids.

The evaporator was either a triple effect falling film evaporator or a double effect rising-falling film evaporator. The material was circulated or held within the evaporator until it obtained a specific gravity of 1.3, which indicates that the material has the desired solids content level (e.g., 64 to 66% by weight). The specific gravity was determined by in-line measurement on the material in a recycle line that is part of the evaporator system (e.g., using a mass flow meter from Micro Motion) and also by testing the material with a handheld hydrometer and Karl Fischer water analysis. Once the material in the evaporator had reached the specific gravity target of 1.3, it was removed from the evaporator and transferred to a final holding tank.

The material in the final holding tank was the maltitol solution of the present invention. This material was tested to determine the HP composition of the maltitol solution and the results of those tests are shown below in Table 1 (in percent by weight of total solids).

TABLE 1
Average HP Distribution of Maltitol Solutions

| | Batch A | Batch B | Batch C | Batch D | Batch E | Batch F | Batch G | Batch H |
|---|---|---|---|---|---|---|---|---|
| HP 1 (Sorbitol) | 2.70 | 2.60 | 2.96 | 2.71 | 2.58 | 3.08 | 2.33 | 2.36 |
| HP 2 (Maltitol) | 94.50 | 94.60 | 94.31 | 94.45 | 94.81 | 94.23 | 95.89 | 95.72 |
| HP 3 compounds | 2.50 | 2.50 | 2.33 | 2.41 | 2.30 | 2.24 | 0.94 | 0.94 |
| HP 4+ compounds | 0.30 | 0.30 | 0.39 | 0.40 | 0.31 | 0.45 | 0.84 | 0.98 |

The inventors expect that successful applications for the maltitol solution of this invention include use in hard and soft candies, syrups, bakery products such as, but not limited to, pastries and cookies, granola bars, energy bars, icings, and savory sauces. A preferred application of the maltitol solutions is to use the solutions to prepare coatings on candy, gum or other confectionary or medicinal products.

Other applications for the maltitol solutions of the present invention include use in oral care products (e.g., mouthwashes and toothpastes), personal care products (e.g., creams and lotions) and industrial processes (e.g., as a raw material in producing polyol based foams).

While the invention has been particularly shown and described with reference to preferred embodiments thereof, it will be understood by those skilled in the art that various changes in form and details may be made without departing from the spirit and scope of the invention as defined in the appended claims.

We claim:

1. A maltitol solution comprising 62 to 68% by weight solids and 32 to 38% by weight water, wherein the solids comprise:

| | |
|---|---|
| (a) | 85 to 99% by weight maltitol; |
| (b) | 0.1 to 7% by weight sorbitol; |
| (c) | 0.1 to 6% by weight HP 3 compounds; and |
| (d) | 0.1 to 3% by weight HP 4+ compounds. |

2. A method of making the maltitol solution of claim 1, wherein said method comprises the steps of:
(a) subjecting a feedstock comprising maltose and glucose to a hydrogenation reaction at temperatures of 100 to 190° C. under a hydrogen atmosphere at a pressure of greater than 200 psig in the presence of a hydrogenation catalyst and a reaction promoter comprising magnesium powder to produce a product comprising maltitol, sorbitol, HP 3 compounds and HP 4+ compounds; and
(b) subjecting the product of step (a) to an ion exchange step and an evaporation step.
